(19) United States
(12) Patent Application Publication
(10) Pub. No.: US 2017/0348694 A1
(43) Pub. Date: Dec. 7, 2017

(54) WEAR RESISTANT ROLLER

(71) Applicant: FLSmidth A/S, Valby (DK)

(72) Inventor: David Dam Olsson, Skodstrup (DK)

(21) Appl. No.: 15/534,778

(22) PCT Filed: Dec. 1, 2015
(86) PCT No.: PCT/DK2015/050371

§ 371 Date: Jun. 9, 2017

(30) Foreign Application Priority Data
Dec. 22, 2014 (DK) PA 2014 70818

(51) Int. Cl. B02C 4/30; B23K 35/24; B23K 10/02

(52) U.S. Cl. CPC B02C 4/305; B23K 10/02; B23K 35/24

(57) ABSTRACT

The invention relates to a wear-resistant roller (1) for crushing of particulate material, such as crude ore for use in the cement or minerals industry comprising a roller body (2), a wear surface (3) on the roller body (2) having an axial extension in an axial direction of the roller and a radial extension in a radial direction of the roller, the wear surface (3) comprising a primary fraction of matrix material and a secondary fraction of hard phase material suspended in the matrix material, wherein the secondary fraction of hard phase material in a central portion of the wear surface is higher than the secondary fraction of hard phase material in a peripheral portion of the wear surface seen in the axial direction of the roller. Also the invention relates to a method of forming such a wear surface on a roller body.

### FIELD OF THE INVENTION

The present invention relates to a wear-resistant roller for crushing of particulate material, such as crude ore for use in the cement or minerals industry comprising a roller body, a wear surface on the roller body. The wear surface comprises welding beads comprising different fractions of hard phase materials. Furthermore, the welding beads have fractions of hard phase materials which are higher in central portions compared to peripheral portions. Also the invention relates to a method of forming such a wear surface on a roller body.

### BACKGROUND ART

Covering roller bodies with a wear surface comprising wear-resistant materials is well-known in the art of milling. The wear surface may comprise wear-resistant materials implemented by wear-resistant studs implemented in the surface or as in wear-resistant rollers of the above-mentioned kind comprise welding beads with high contents of carbide. Carbides have long been known to have a hardness close to that of diamond and has consequently been used extensively for cutting or grinding in situations requiring extreme resistance to wear and abrasions. Welding beads comprising wear and abrasion resistant materials welded on a roller is often referred to as hardfacing of the roller. Using studded technologies is often too expensive either to install or maintain, and often also inadequate when working with very high pressures such as in roller mills or roller crushers due to failure of attachment to the roller body. The wear-resistant material of which the studs are made is very expensive and since a part of each stud is embedded in the roller for fastening the stud, and only a smaller portion of the stud protrudes from the roller surface and is actually utilized as wear-resistant material, most of the expensive material is not subjected to wear, which is a poor utilization of the wear-resistant material.

Hardfacing on the other hand has the advantage of being less expensive, fairly easy to maintain and capability of withstanding extremely high pressures. However, a well-known disadvantage of hardfacing is the decrease in grinding effectiveness as a consequence of un-even wear of the wear surface of the roller across the width of the roller. To ensure a reasonable service lifetime of the roller between consecutive hardfacing, the hardfacing technology has conventionally been limited to using expensive high wear-resistant materials.

Therefore it would be advantageous to be able to use hard-faced surfaces while maintaining a more even wear distribution of the wear surface of the roller to optimize the wear resistance of the roller, maintain a high grinding efficiency to increase the service life of the roller.

### SUMMARY OF THE INVENTION

It is an object of the present invention to wholly or partly overcome the above disadvantages and drawbacks of the prior art. More specifically, it is an object to provide an improved wear-resistant roller of the kind mentioned in the introduction, wherein the wear surface comprises a high fraction of hard phase materials in a central portion of the wear surface and a lower fraction of hard phase material in a peripheral portion of the wear surface seen in the axial direction of the roller. Also, it is an object of the present invention to provide a method of forming a wear surface on a roller body characterized in welding a first welding bead to a central portion of a wear-resistant roller, said first welding bead comprising a first secondary fraction of carbide material, welding a second welding bead to a peripheral portion of the wear-resistant roller, said second welding bead comprising a second secondary fraction of carbide material, said second fraction of carbide material being lower than said first secondary fraction of carbide material.

The above objects, together with numerous other objects, advantages, and features, which will become evident from the below description, are accomplished by a solution in accordance with the present invention by a wear-resistant roller for crushing of particulate material, such as crude ore for use in the cement or minerals industry, comprising a roller body, a wear surface on the roller body having an axial extension in an axial direction of the roller and a radial extension in a radial direction of the roller, and the wear surface comprising a primary fraction of matrix material and a secondary fraction of hard phase material suspended in the matrix material, wherein the secondary fraction of hard phase material in a central portion of the wear surface is higher than the secondary fraction of hard phase material in a peripheral portion of the wear surface seen in the axial direction of the roller.

The advantage of having lower contents of hard phase materials in peripheral portions of the wear surface is that they wear off as quickly as the central portions which are exposed to much higher wear, since the grinding pressure is higher in the central portions.

In one embodiment of the invention, a distal portion of the wear surface comprises a higher fraction of hard phase material than a proximal portion of the wear surface seen in the radial direction of the roller.

In another embodiment of the invention, the wear surface comprises a plurality of central portions of the wear surface, wherein said plurality of central portions comprise secondary fractions of hard phase material being higher than the secondary fraction of hard phase material in a peripheral portion of the wear surface.

In an embodiment of the invention, the wear surface comprises a plurality of distal portions of the wear surface, wherein said plurality of distal portions comprise secondary fractions of hard phase material being higher than the secondary fraction of hard phase material in the proximal portion of the wear surface.

In an embodiment of the invention, the wear surface is made from a plurality of Plasma Transfer Arc (PTA) welding beads comprising at least two different secondary fractions of hard phase material.

In an embodiment of the invention, the wear surface is made from a plurality of laser cladded deposits comprising at least two different secondary fractions of hard phase material.

Laser cladding is a method of depositing material by which a powdered or wire feedstock material is melted and consolidated by use of a laser in order to coat the roller with a wear surface having different fractions of hard phase material in different portions of the wear surface.

In an embodiment of the invention, the wear surface is made from a matrix of Plasma Transfer Arc (PTA) welding beads comprising a plurality of different secondary fractions of hard phase material.

In an embodiment of the invention, the wear surface is made from a plurality of Plasma Transfer Arc (PTA) welding beads comprising a plurality of different secondary fractions of hard phase material continuously changing from a high concentration level to a low concentration level of secondary fractions of hard phase material.

In an embodiment of the invention, the primary fraction of matrix material is selected from a group consisting of Nickel, Iron, Cobalt and alloys thereof.

In an embodiment of the invention, the secondary fraction of hard phase material is selected from a group consisting of Wolfram Carbide, Titanium Carbide, Vanadium Carbide, Niobium Carbide, Silicon Carbide, Boron Carbide, Chromium Carbide, Tantalum Carbide, Aluminium Oxide and solid solutions thereof.

In an embodiment of the invention, the central part of the wear surface preferably comprises 40-75%, or more preferably 50-72% or even more preferably 55-70% of the secondary fraction of hard phase material and wherein the peripheral portion preferably comprises 30-50%, or more preferably 35-45% or even more preferably 38-42% of secondary fraction of hard phase material.

In an embodiment of the invention, wherein the distal part of the wear surface preferably comprises 40-75%, or more preferably 50-72% or even more preferably 55-70% of the secondary fraction of hard phase material and wherein the proximal portion preferably comprises 30-50%, or more preferably 35-45% or even more preferably 38-42% of secondary fraction of hard phase material.

In an embodiment of the invention, the wear surface comprises a series of circumferential welding beads comprising at least two different secondary fractions of hard phase material.

In an embodiment of the invention, the welding beads preferably have a width of preferably 8 mm to 24 mm, or more preferably a width of from 10 mm to 22 mm or even more preferably a width of from 12 mm to 20 mm.

According to an embodiment of the invention, a roller mill comprises a feed of material, at least one wear-resistant roller as described above for comminution of the feed of material, and the mill being a roller press or a vertical mill.

In an embodiment of the invention, the wear surface comprises a plurality of central portions of the wear surface, wherein said plurality of central portions comprise secondary fractions of hard phase material being higher than the secondary fraction of hard phase material in a peripheral portion of the wear surface, and wherein the secondary fractions of hard phase material continuously increases from the highest fraction being in the most central portion to the lowest fraction being in the most peripheral portion of the central portions.

In an embodiment of the invention, the wear surface comprises a plurality of distal portions of the wear surface, wherein said plurality of distal portions comprise secondary fractions of hard phase material being higher than the secondary fraction of hard phase material in a proximal portion of the wear surface, and wherein the secondary fractions of hard phase material continuously increases from the highest fraction being in the most distal portion to the lowest fraction being in the most proximal portion of the distal portions.

In a method of forming a wear surface on a roller body according to the invention, the method comprises the steps of welding a first welding bead to a central portion of a wear-resistant roller, said first welding bead comprising a first secondary fraction of carbide material and welding a second welding bead to a peripheral portion of the wear-resistant roller, said second welding bead comprising a second secondary fraction of carbide material, said second fraction of carbide material being lower than said first secondary fraction of carbide material.

In an embodiment of the method according to the invention, the method further comprising the steps of welding a third welding bead to a distal portion of the wear-resistant roller, said third welding bead comprising a third secondary fraction of carbide material, welding a forth welding bead to a proximal portion of the wear-resistant roller, said forth welding bead comprising a forth secondary fraction of carbide material, said forth fraction of carbide material being lower than said third secondary fraction of carbide material.

### BRIEF DESCRIPTION OF THE DRAWINGS

The invention and its many advantages will be described in more detail below with reference to the accompanying schematic drawings, which for the purpose of illustration show some non-limiting embodiments and in which

FIG. 1 shows a cross-sectional view of a wear-resistant roller of the prior art,

FIG. 2 shows a cross-sectional view of a wear-resistant roller of the invention,

FIG. 3 shows a cross-sectional view of a wear-resistant roller of the invention,

FIG. 4 shows a schematic and magnified view of hard phase material (HPM) suspended in a matrix material (MM),

FIG. 5a shows a cross-sectional view of a section of a wear surface,

FIG. 5b shows a cross-sectional view of a section of a wear surface,

FIG. 6a shows a cross-sectional view of a vertical roller mill of the prior art,

FIG. 6b shows a cross-sectional view of a vertical roller mill of the prior art,

FIG. 7 shows a cross-sectional view of a section of a wear surface,

FIG. 8a shows a cross-sectional view perspective view of a vertical roller mill of the invention,

FIG. 8b shows a cross-sectional view of a vertical roller mill of the invention,

FIG. 9 shows a perspective view of a roller mill, and

FIG. 10 shows a perspective view of a vertical roller mill.

### All the FIGS. are highly schematic and not necessarily to scale, and they show only those parts which are necessary in order to elucidate the invention, other parts being omitted or merely suggested.

### DETAILED DESCRIPTION OF THE INVENTION

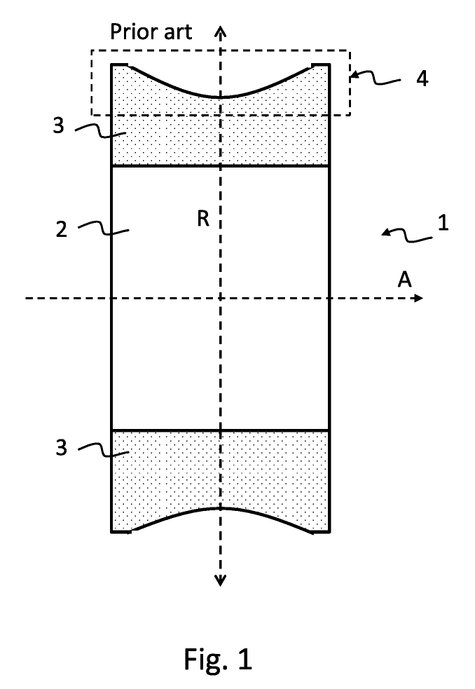

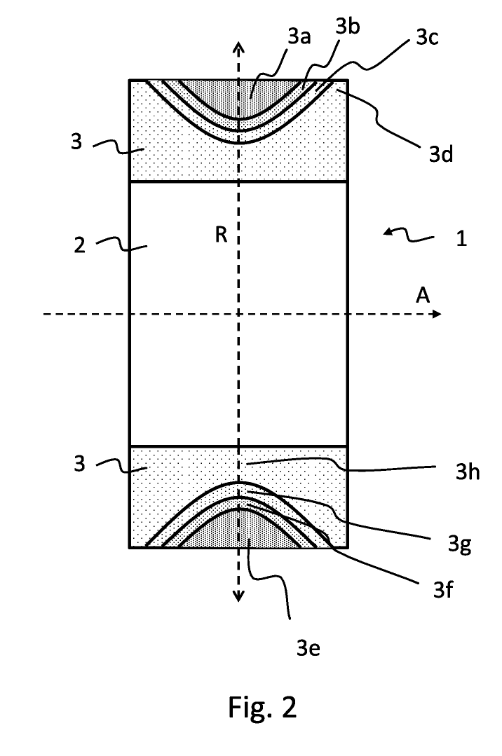

FIG. 1 shows a cross-sectional view of a wear-resistant roller 1 of the prior art comprising a roller body 2 and a wear surface 3 on the roller body. The wear surface 3 has been worn in a central portion of the wear surface leaving an uneven wear surface profile 4, since the wear surface 3 has been partially worn off in the central part of the roller. The wear surface 3 on the roller body 2 has an axial extension in an axial direction A of the roller and a radial extension in a radial direction R of the roller. FIG. 2 schematically shows how in an embodiment of the wear-resistant roller 1 of the invention, the wear surface comprises a plurality of portions 3a-3h. As shown in FIG. 2, the microstructure of the wear surface 3 comprises a primary fraction of matrix material MM and a secondary fraction of hard phase material HPM suspended in the matrix material. In FIG. 1 the secondary fraction of hard phase material HPM in a central portion 3a of the wear surface 3 is higher than the secondary fraction of hard phase material HPM in a peripheral portion 3d of the wear surface 3 seen in the axial direction A of the roller. The central portion of the roller is often exposed to the highest wear during grinding, therefore having the most wear-resistant material in the central portions is essential to the invention. Further, the more peripheral portions are exposed to lower wear rates leading to uneven wear across the width of the roller. However, by arranging wear material of a lower wear resistance in the more peripheral portions of the roller a controlled wear pattern may be obtained increasing the service lifetime of the roller, since the peripheral portions may be designed by choosing a lower wear resistance to wear off at the same rate as the central portions resulting in a more evenly distributed wear profile. As shown in FIG. 1, a typical wear surface profile 4 of the prior art is very uneven, which results in a requirement for high frequency of new hardfacing of the surface. After a certain period of operation, the material to be grinded becomes trapped in the worn-off central portion of the wear surface leading to a decrease in grinding efficiency compared to a new or recently hard-faced wear surface. To avoid this effect conventional wear services are frequently hard-faced.

Hardfacing is the deposition of thick coatings of hard, wear-resistant materials on a worn or new component surface that is subject to wear during operation.

More also indicated in FIG. 1 a distal portion 3e of the wear surface 3 comprises a higher fraction of hard phase material HPM than a proximal portion 3h of the wear surface 3 seen in the radial direction R of the roller. Hard phase materials HPM are often expensive, but also very brittle. Therefore, limiting the use of hard phase materials in portions of the wear surface 3 not exposed to very high wear conditions not only reduces the cost of the wear surface, but also increases the resilient or ductile strength of the wear surface. Therefore, having a higher secondary fraction of hard phase materials in more distal portions as compared to proximal portion both lowers the cost of the roller and increases the resilient ductile strength. Resilient or ductile strength of the roller wear surface is important with respect to accidental grinding on foreign objects such as steel lumps etc. or big lumps of hard phased feed material inducing a large deformation in the wear surface. If the entire roller surface was made from brittle material with high secondary fractions of hard phase material, the wear surface may be prone to cracking even though high wear resistance may be achieved.

Proximal indicates close to the centre of the roller, whereas distal indicates close to the grinding surface of the roller. Central indicates the mid-section of the roller, whereas peripheral indicates closer to the edge of the wear surface roller in the axial direction of the roller.

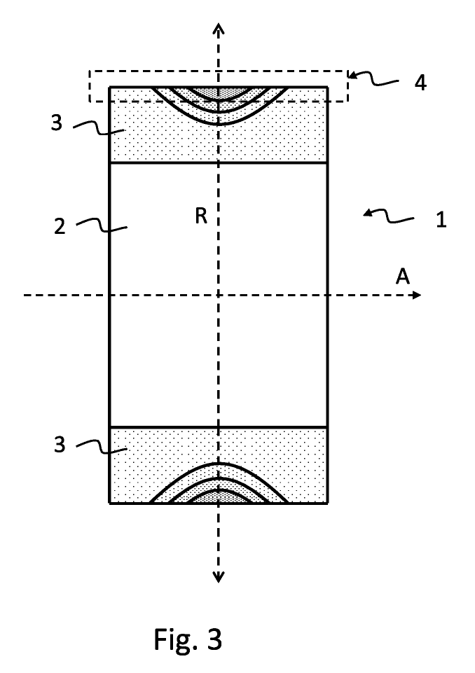

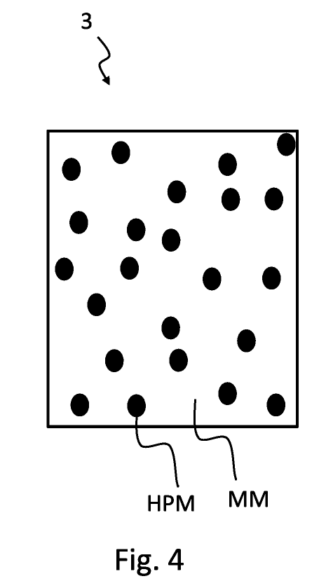

Further, as seen in FIG. 2, the wear surface may comprise a plurality of central portions 3a, 3b, 3c comprising secondary fractions of hard phase material HPM being higher than the secondary fraction of hard phase material HPM in a peripheral portion 3d of the wear surface 3. To ensure a controlled wear pattern several central portions, each having different fractions higher than the peripheral portion, may be advantageous to ensure an even wear surface profile 4, as shown in FIG. 3. Further, the wear surface 3 may comprises a plurality of distal portions 3e, 3f, 3g comprising secondary fractions of hard phase material HPM being higher than the secondary fraction of hard phase material HPM in the proximal portion 3h of the wear surface 3 to also control the wear surface profile by changing the secondary fractions of hard phase material HPM in the radial direction of the wear surface.

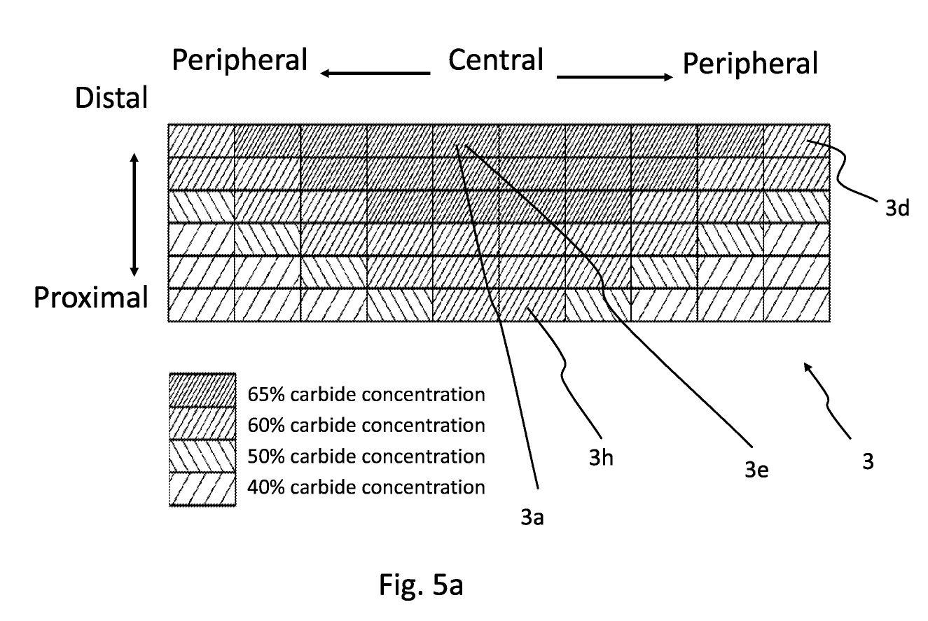

FIG. 5a shows a section of a wear surface 3 according to the invention, wherein the wear surface 3 of the roller is made from a matrix of welding beads having different secondary fractions of hard phase material. As indicated, the secondary fraction (here being a wolfram carbide concentration in a nickel-based metal matrix) is here changed from 40% in the proximal and peripheral corner to a 65% carbide concentration in the central and distal portion of the wear surface 3. The wear surface 3 comprises a high fraction of hard phase materials in a central portion 3a of the wear surface and a lower fraction of hard phase material in a peripheral portion 3d of the wear surface and a distal portion 3e of the wear surface comprises a higher fraction of hard phase material than a proximal portion 3h of the wear surface 3 seen in the radial direction of the roller.

FIG. 5b shows a section of a wear surface 3 according to the invention, wherein the wear surface 3 of the roller is made from a matrix of welding beads having different secondary fractions of hard phase material. As indicated, the secondary fraction (here being a wolfram carbide concentration in a nickel-based metal matrix) is here changed from 40% in the proximal and peripheral corner to a 65% carbide concentration in the central and distal portion of the wear surface 3. The wear surface 3 comprises a high fraction of hard phase materials in a central portion 3a of the wear surface and a lower fraction of hard phase material in a peripheral portion 3d of the wear surface

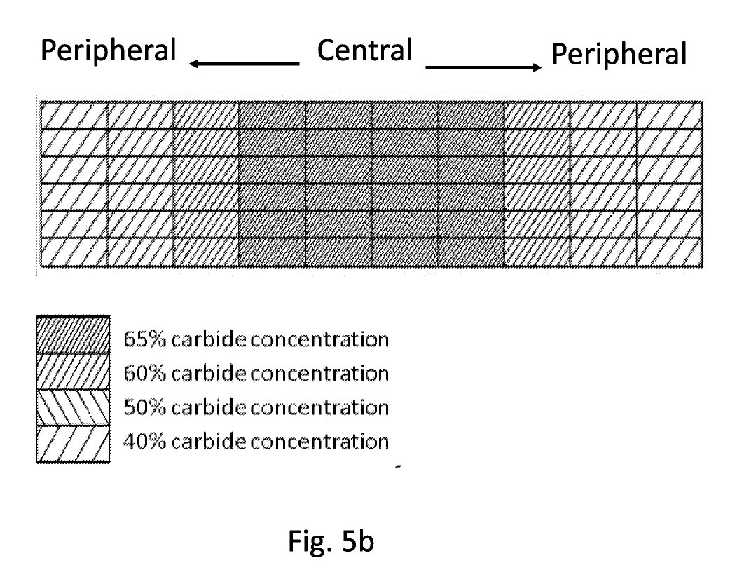

FIG. 6a shows a cross-sectional view of a conventional vertical roller mill comprising a vertical roller mill roller 21 and a vertical roller mill grinding table 22.

FIG. 6b shows a cross-sectional view of a worn conventional vertical roller mill where the wear surfaces 3 has been partially worn off. The dotted line indicates the unworn profiles P1, P3 of the wear surface 3 also shown in FIG. 6a and the full line indicates the worn profiles P2, P4 of the wear surfaces 3. As seen in FIG. 6b, the worn profiles P2, P4 are not symmetrical around the centre line as seen in the case of a roller press FIGS. 1-3. Therefore the graduation of carbide concentrations should match the wear profile to reduce this uneven wear.

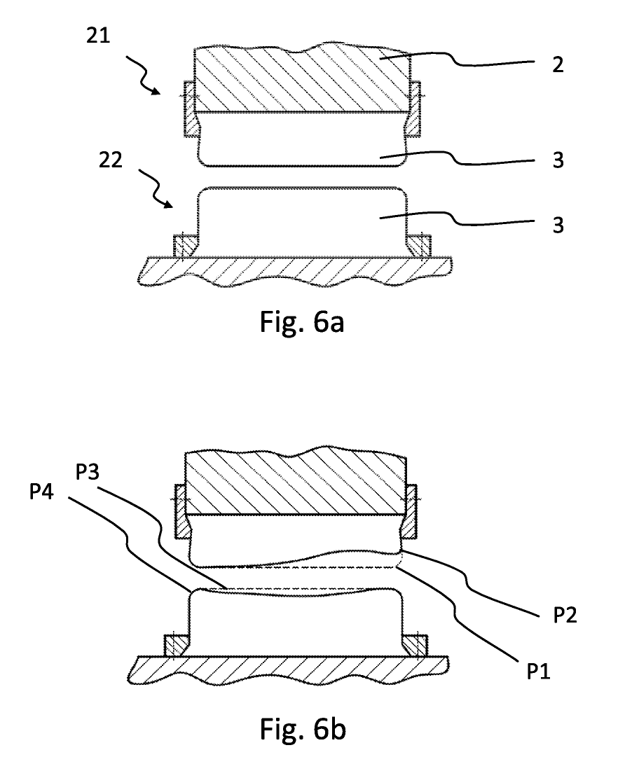

FIG. 7 shows two opposing wear surfaces 31, 32 according to the invention where the central parts of the wear surfaces having a high carbide concentration are not centred around the centre line in the uppermost wear surface 31 to counter the asymmetrical wear seen in FIG. 6b. Uppermost is seen a wear surface 31 of a roller of the vertical roller mill according to the invention and lowermost is seen an opposing section of a wear surface 31 of a grinding table of the vertical roller mill according to the invention wherein the wear surfaces 31, 32 are made from a matrix of welding beads having different secondary fractions of hard phase material. As indicated the secondary fraction (here being a wolfram carbide concentration in a nickel-based metal matrix) is here changed from 40% in the proximal and peripheral corner to a 65% carbide concentration in the central and distal portion of the wear surface 3, explanation of the hatching is seen in FIG. 5a, 5b.

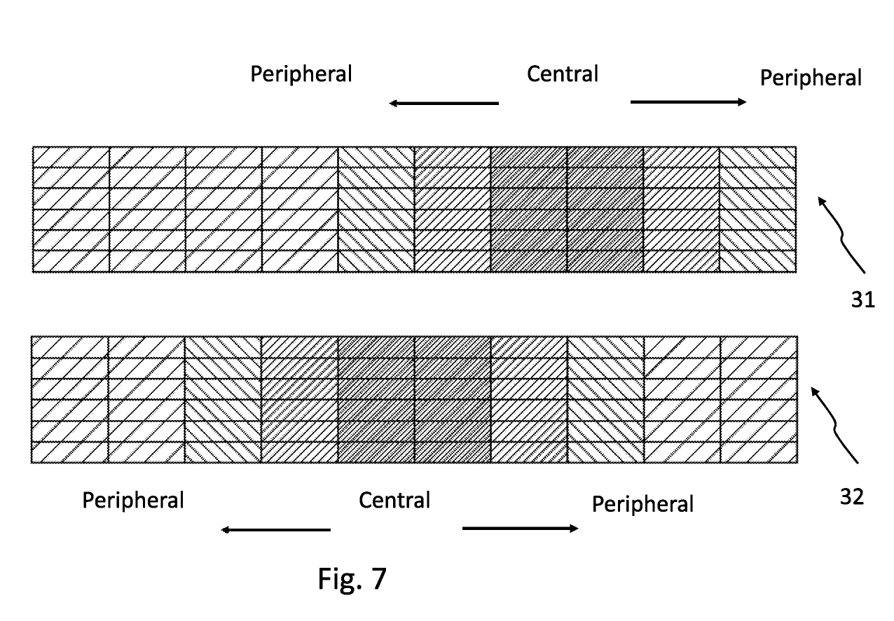

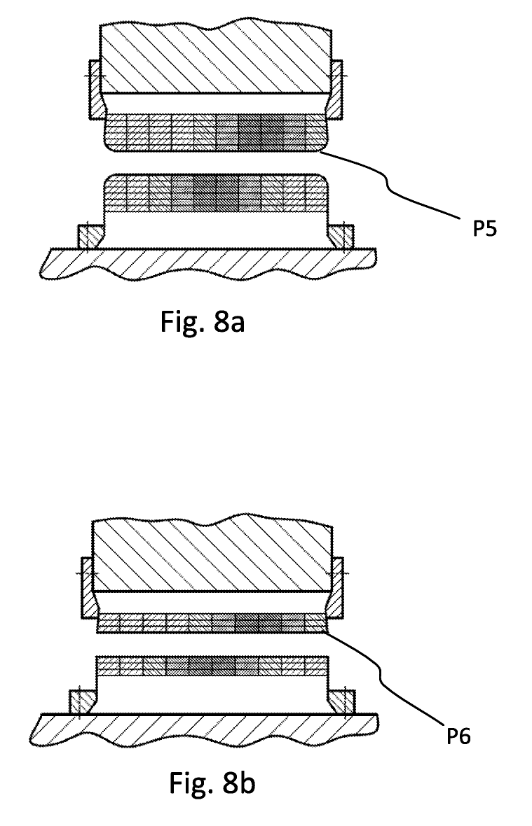

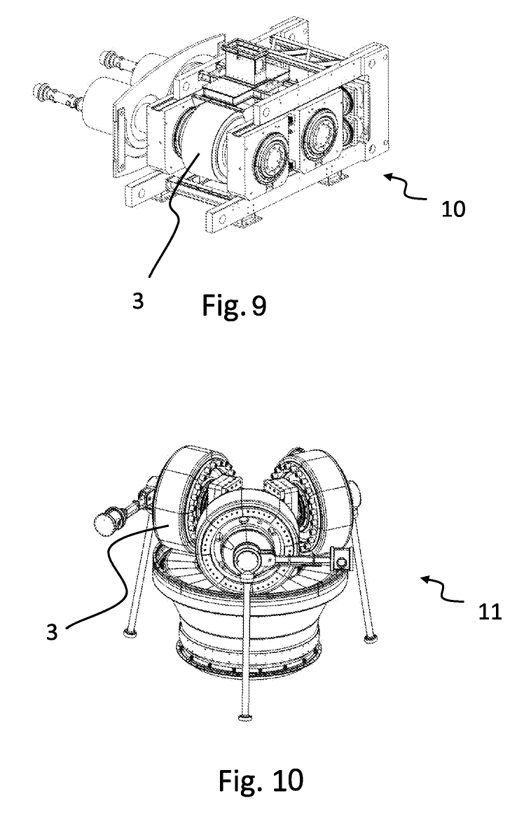

FIG. 8a shows the wear surfaces 31, 32 from FIG. 7 implemented in a vertical roller mill, said wear surfaces having an unworn profile P5. In FIG. 8b the worn wear surfaces 3 with a worn surface profile P6 is shown in a vertical roller mill having the wear surface of the invention. As demonstrated in FIG. 8b the worn wear surface profile P6 is substantially parallel compared with the un-worn wear surface profile seen in FIG. 8a. Since the wear surface 3 of the invention is worn off more evenly than the prior art, the wear surface will last longer, thus reducing downtime on equipment, and improving service life. Also since the high wear resistant areas are reduced, more expensive materials with higher carbide concentrations may be used without increasing cost of the wear surface.

Advantageous welding bead widths preferably lie in the range of 8 mm to 24 mm, or more preferably a width of from 10 mm to 22 mm or even more preferably a width of from 12 mm to 20 mm.

The wear-resistant roller 1 according to the invention may be implemented in a roller press 10, a vertical mill 11 or other appropriate grinding apparatus or comminution devices. Perspective views of a roller press 10 and a vertical mill 11 are shown in FIGS. 6 and 7.

In a method of forming a wear surface on a roller body according to the invention a first step comprises welding a first welding bead to a central portion of a wear-resistant roller, said first welding bead comprising a first secondary fraction of hard phase material. After the first welding bead a second welding bead is welded to the roller body, a second welding bead is welded to a peripheral portion of the wear-resistant roller, said second welding bead comprising a second secondary fraction of hard phase material, said second fraction of hard phase material being lower than said first secondary fraction of hard phase material. The difference in secondary fraction of hard phase material partial overlap ensures re-heating of the overlapping volume thereby increasing the wear resistance in this volume by up-concentration of carbides in the lower parts of the overlapping volume close to the roller body.

In a method of forming a wear surface on a roller body according to the invention, the method comprises the steps of welding a third welding bead to a distal portion of the wear-resistant roller, said third welding bead comprising a third secondary fraction of hard phase material, and welding a forth welding bead to a proximal portion of the wear-resistant roller, said forth welding bead comprising a forth secondary fraction of hard phase material, said forth fraction of hard phase material being lower than said third secondary fraction of hard phase material.

The wear surface may comprise a series of circumferential welding beads, wherein neighbouring circumferential welding beads have different secondary fractions of HPM and substantially follow the circumferential direction of the wear-resistant roller. However, in some embodiments of the invention the welding beads instead of having a linear shape have a sinusoidal shape, a zigzag shape or a step-function shape in the circumferential direction.

Vertical mills are common machines for grinding various mineral ores and are widely used within cement production. Vertical mills are characterized by having a horizontal grinding table, which is driven by a gear and motor unit. A number of vertical rollers are positioned on top of the grinding table along its periphery, as seen in FIG. 11. Feed material is crushed by the rolling action between vertical rollers and table. The crushed feed material gradually moves towards the outer periphery of the grinding table at which it will be lifted upwards by an airstream.

Due to the rolling dynamics between the grinding table and vertical rollers, an asymmetric wear profile appears on both counteracting surfaces, as seen in FIG. 7. The asymmetric wear profile appears despite the geometrical shape of the vertical rollers (spherical, conical or cylindrical) as well as table (spherical or flat). The wear profile implies reduced efficiency of the vertical mill thus increased operational cost. It is therefore desirable to achieve a wear profile to ensure that the counteracting surfaces of table and rollers are substantially parallel during the entire operational lifetime when the wear surfaces gradually wears off.

1. A wear-resistant roller for crushing of particulate material, such as crude ore, for use in the cement or minerals industry comprising:
a roller body,
a wear surface on the roller body having an axial extension in an axial direction of the roller and a radial extension in a radial direction of the roller,
the wear surface comprising a primary fraction of matrix material and a secondary fraction of hard phase material suspended in the matrix material,
wherein the secondary fraction of hard phase material in a central portion of the wear surface is higher than the secondary fraction of hard phase material in a peripheral portion of the wear surface seen in the axial direction of the roller.

2. The wear-resistant roller of claim 1, wherein a distal portion of the wear surface comprises a higher fraction of hard phase material than a proximal portion of the wear surface seen in the radial direction of the roller.

3. The wear-resistant roller of claim 1, wherein the wear surface comprises a plurality of central portions of the wear surface, wherein said plurality of central portions comprise secondary fractions of hard phase material being higher than the secondary fraction of hard phase material in a peripheral portion of the wear surface.

4. The wear-resistant roller of claim 2, wherein the wear surface comprises a plurality of distal portions of the wear surface, wherein said plurality of distal portions comprise secondary fractions of hard phase material being higher than the secondary fraction of hard phase material in the proximal portion of the wear surface.

5. The wear-resistant roller of claim 1, wherein the wear surface is made from a plurality of plasma transfer arc welding beads comprising at least two different secondary fractions of hard phase material.

6. The wear-resistant roller of claim 1, wherein the primary fraction of matrix material is selected from a group consisting of nickel, iron, cobalt and alloys thereof.

7. The wear-resistant roller of claim 1, wherein the secondary fraction of hard phase material is selected from a group consisting of wolfram carbide, titanium carbide, vanadium carbide, niobium carbide, silicon carbide, boron carbide, chromium carbide, tantalum carbide, aluminium oxide or solid solutions thereof.

8. The wear-resistant roller of claim 1, wherein the central part of the wear surface comprises 40-75% of the secondary fraction of hard phase material and wherein the peripheral portion comprises 30-50% of secondary fraction of hard phase material.

9. The wear-resistant roller of claim 2, wherein the distal part of the wear surface comprises 40-75% of the secondary fraction of hard phase material and wherein the proximal portion comprises 30-50% of secondary fraction of hard phase material.

10. A method of forming a wear surface on a roller body, the method comprising the steps of:
welding a first welding bead to a central portion of a wear-resistant roller, the first welding bead comprising a first secondary fraction of carbide material,
welding a second welding bead to a peripheral portion of the wear-resistant roller, the second welding bead comprising a second secondary fraction of carbide material, the second fraction of carbide material being lower than the first secondary fraction of carbide material.

11. A method of forming a wear surface on a roller body according to claim 10, the method further comprising the steps of:
welding a third welding bead to a distal portion of the wear-resistant roller, the third welding bead comprising a third secondary fraction of carbide material,
welding a forth welding bead to a proximal portion of the wear-resistant roller, the forth welding bead comprising a forth secondary fraction of carbide material, the forth fraction of carbide material being lower than said third secondary fraction of carbide material.
